(19) United States
(12) Patent Application Publication
(10) Pub. No.: US 2025/0176589 A1
(43) Pub. Date: Jun. 5, 2025

(54) PLANT-BASED MEAT ALTERNATIVE COMPOSITIONS FOR FOODSERVICE AND PREPARATION METHODS THEREOF

(71) Applicant: MGPI PROCESSING, INC., ATCHISON, KS (US)

(72) Inventors: TANYA JERADECHACHAI, PLATTE CITY, MO (US); YVETTE HIRANG, LENEXA, KS (US); CLODUALDO MANINGAT, PLATTE CITY, MO (US); MICHAEL BUTTSHAW, PLATTE CITY, MO (US)

(73) Assignee: MGPI PROCESSING, INC., ATCHISON, KS (US)

(21) Appl. No.: 18/844,147

(22) PCT Filed: Mar. 16, 2023
(86) PCT No.: PCT/US2023/015338

§ 371 Date: Sep. 5, 2024

Related U.S. Application Data
(60) Provisional application No. 63/320,400, filed on Mar. 16, 2022.

(51) Int. Cl. A23J 3/22; A23J 3/14; A23J 3/18

(52) U.S. Cl. CPC A23J 3/227; A23J 3/14; A23J 3/18

(57) ABSTRACT

In one aspect, the present invention is directed to a method of preparing a plant-based food product comprising a plant-based composition. In another aspect, the present invention is directed to a method of hot holding a plant-based food product. In another aspect, the present invention is directed to a method of preparing a plant-based food product. The plant-based food product includes a plant-based composition. In another aspect, the present invention is directed to a plant-based food product that includes a plant-based composition. The plant-based composition includes a textured protein and seasoning.

### FIELD OF THE INVENTION

The present invention generally relates the use of plant-based proteins in a foodservice setting, where the plant-based proteins can be cooked in different types of ovens and held on a steam table with minimal disintegration in quality. Likewise, the cooked plant-based proteins could be refrigerated, frozen, and reheated. The present invention also relates to stable plant-based meat alternative compositions. The compositions, when cooked to form a plant-based food product, possess improved and lasting hot holding properties, stability, and desirable texture and flavor. The present invention also relates to methods of preparing and hot holding meals/dishes using the plant-based meat alternative compositions that have the appearance, fibrous structure, texture, and other properties resembling animal meat.

### BACKGROUND TO THE INVENTION

Food product offerings in many foodservice facilities are principally meat-based with limited options for plant-based meat alternatives. While vegetarian and vegan diets have existed for decades, the plant-based revolution is currently attracting a new breed of consumers who are looking to achieve a healthier and sustainable diet by incorporating more plant-based foods into their diet. However, plant-based meat alternative products are not readily available in commercial foodservice outlets, especially in college and corporate cafeterias. The reasons for this are that it is technologically challenging to create a textured plant protein product to simulate real meat and to develop a shelf-stable and savory composition that has the ease and versatility to be prepared into a variety of meals/dishes.

In the context of commercial foodservice outlets, the ingredients of meals are typically assembled, prepared and served on the same premises. This system requires the production of a significant quantity of food and maintenance of the temperature of the cooked food for an extended period of time (e.g., using a steamer/food warmer or other heating apparatus). Previously, plant-based food products were known to deteriorate in quality, appearance, and/or structure when stored at an elevated temperature for an extended period of time.

Therefore, there exists a need for improved plant-based meat alternative compositions and products that are capable of storage at an elevated temperature while maintaining a commercially acceptable quality, appearance, and structure of the composition or food product.

### SUMMARY OF THE INVENTION

In a first aspect, the present invention is directed to a method of preparing a plant-based food product comprising a plant-based composition. The method includes the following steps: mixing a textured protein and seasoning to prepare the plant-based composition; combining the plant-based composition and water to form a hydrated plant-based composition; and cooking the hydrated plant based composition to form the plant-based food product. The weight ratio of textured protein to seasoning in the plant-based composition is from about 20:1 to about 2:1, from about 15:1 to about 2:1, from about 10:1 to about 2:1, from about 9:1 to about 2:1, from about 8:1 to about 2:1, from about 7:1 to about 2:1, from about 6:1 to about 2:1, from about 5:1 to about 2:1, from about 4:1 to about 2:1, or from about 3:1 to about 2:1. The plant-based food product maintains a commercially acceptable appearance, quality, and structure after hot holding at a temperature of from about 135° F. to about 212° F., from about 135° F. to about 200° F., from about 140° F. to about 200° F., from about 145° F. to about 200° F., from about 150° F. to about 200° F., from about 155° F. to about 200° F., from about 160° F. to about 200° F., from about 160° F. to about 195° F., from about 160° F. to about 190° F., from about 160° F. to about 185° F., or from about 160° F. to about 180° F. for a period of about 10 minutes or less, about 15 minutes or less, about 20 minutes or less, about 25 minutes or less, about 30 minutes or less, about 35 minutes or less, about 40 minutes or less, about 45 minutes or less, about 50 minutes or less, about 55 minutes or less, about 60 minutes or less, about 70 minutes or less, about 80 minutes or less, about 90 minutes or less, about 100 minutes or less, about 110 minutes or less, about 120 minutes or less, about 130 minutes or less, about 140 minutes or less, or about 150 minutes or less.

In a second aspect, the present invention is directed to a method of hot holding a plant-based food product. The method includes the following steps: preparing a plant-based food product comprising a plant-based composition comprising a textured protein and seasoning, wherein the weight ratio of textured protein to seasoning is from about 20:1 to about 2:1, from about 15:1 to about 2:1, from about 10:1 to about 2:1, from about 9:1 to about 2:1, from about 8:1 to about 2:1, from about 7:1 to about 2:1, from about 6:1 to about 2:1, from about 5:1 to about 2:1, from about 4:1 to about 2:1, or from about 3:1 to about 2:1; placing the plant-based food product in a container; and maintaining the container at a temperature of from about 135° F. to about 212° F., from about 135° F. to about 200° F., from about 140° F. to about 200° F., from about 145° F. to about 200° F., from about 150° F. to about 200° F., from about 155° F. to about 200° F., from about 160° F. to about 200° F., from about 160° F. to about 195° F., from about 160° F. to about 190° F., from about 160° F. to about 185° F., or from about 160° F. to about 180° F. for a period of about 10 minutes or less, about 15 minutes or less, about 20 minutes or less, about 25 minutes or less, about 30 minutes or less, about 35 minutes or less, about 40 minutes or less, about 45 minutes or less, about 50 minutes or less, about 55 minutes or less, about 60 minutes or less, about 70 minutes or less, about 80 minutes or less, about 90 minutes or less, about 100 minutes or less, about 110 minutes or less, about 120 minutes or less, about 130 minutes or less, about 140 minutes or less, or about 150 minutes or less.

In certain embodiments of the method of the second aspect of the present invention, the container is a steam table, buffet line, or oven.

In certain embodiments of the methods of the first and/or second aspects of the present invention, the seasoning includes at least about 1 wt %, at least about 2 wt %, at least about 3 wt %, at least about 4 wt %, at least about 5 wt %, at least about 6 wt %, at least about 7 wt %, at least about 8 wt %, at least about 9 wt %, or at least about 10 wt % of the plant-based composition.

In certain embodiments of the methods of the first and/or second aspects of the present invention, at least a portion of the textured protein is derived from wheat, pea, corn, fungus, or other plant sources.

In certain embodiments of the methods of the first and/or second aspects of the present invention, the textured protein may include a textured wheat protein. The textured wheat protein may be produced by extrusion of wheat gluten with wheat starch, tetrapotassium pyrophosphate, caramel color, sodium carbonate, and mixed tocopherols as processing aids.

In certain embodiments of the methods of the first and/or second aspects of the present invention, the textured protein may include a textured pea protein. The textured pea protein is produced by extrusion of pea protein isolate. The proximate protein content of the extrudate may be greater than about 50%, greater than about 55%, greater than about 60%, greater than about 65%, greater than about 70%, greater than about 75%, greater than about 80%, greater than about 85%, or greater than about 90%. The pea protein isolate may further include additives. The additives may include tapioca starch, sodium carbonate, mixed tocopherols, and combinations thereof. The textured pea protein may be dry, refrigerated, or frozen. The textured pea protein may be in the form of crumbles, granules, strings, shreds, or chips. The textured pea protein may have a protein quality of 0.81 based on the in vitro PDCAAS (Protein Digestibility Corrected Amino Acid Score) value.

In certain embodiments of the methods of the first and/or second aspects of the present invention, the seasoning is barbacoa seasoning, chimichurri seasoning, tikka masala seasoning, stroganoff seasoning, pulled pork BBQ seasoning, or combinations thereof. Barbacoa seasonings may include dehydrated onion and garlic, spices, yeast extract, maltodextrin, salt, smoked paprika, natural flavors, and silicon dioxide. Chimichurri seasonings may include a blend of dehydrated garlic and onion, yeast extract, salt, spices, sugar, maltodextrin, lemon juice powder (maltodextrin, lemon juice concentrate), natural flavors, lime juice powder (lime juice, maltodextrin), citric acid, and silicon dioxide. Tikka masala seasonings may include a blend of spices, dehydrated onion and garlic, yeast extract, tomato powder, salt, paprika, maltodextrin, turmeric, natural flavors, lemon juice powder (maltodextrin, lemon juice concentrate), modified corn starch, and silicon dioxide. Stroganoff seasonings may include a blend of corn starch, dehydrated onion and garlic, salt, dextrose, mushroom powder, sugar, yeast extract, spices, natural flavors, and silicon dioxide. Pulled pork BBQ seasoning may include a blend of demerara cane sugar, dehydrated vegetables (tomato, onion, garlic), spices, maltodextrin, natural flavors (natural flavor, yeast extract, salt, smoke flavor, torula yeast, molasses, tapioca starch), paprika, vinegar powder (maltodextrin, white distilled vinegar), and silicon dioxide.

In certain embodiments of the methods of the first and/or second aspects of the present invention, the nutritional value of the plant-based food product may be about 11 g of protein, about 1 g of fat, about 1 g of fiber, and about 70 calories per serving size of about 18 g (¼ cup).

In certain embodiments of the methods of the first and/or second aspects of the present invention, the plant-based food product is prepared by: mixing the textured protein and seasoning for about 1 minute to prepare the plant-based composition; combining the plant-based composition and water for about 2 minutes to form a hydrated plant-based composition; and cooking the hydrated plant-based composition for about 6 minutes in a combi/steamer to form the plant-based food product.

In certain embodiments of the methods of the first and/or second aspects of the present invention, the plant-based food product is prepared by: mixing the textured protein and seasoning for about 1 minute to prepare the plant-based composition; combining the plant-based composition and water for about 2 minutes to form a hydrated plant-based composition; and cooking the hydrated plant-based composition for about 20 minutes in a convection oven to form the plant-based food product.

In certain embodiments of the methods of the first and/or second aspects of the present invention, the plant-based food product is prepared by: mixing the textured protein and seasoning for about 1 minute to prepare the plant-based composition; combining the plant-based composition and water for about 2 minutes to form a hydrated plant-based composition; and cooking the hydrated plant-based composition for about 25 minutes in a standard oven to form the plant-based food product.

In certain embodiments of the methods of the first and/or second aspects of the present invention, the plant-based food product is hot held in a container selected from a steam table or buffet line for about 2 hours at about 180° F. without deterioration of product quality.

In a third aspect, the present invention is directed to a method of preparing a plant-based food product comprising a plant-based composition. The method includes the following steps: mixing a textured protein and seasoning to prepare the plant-based composition; pouring hot water, having a temperature from about 43° C. to about 85° C., on the plant-based composition; and allowing the product to hydrate for a period of from about 2 to about 7 min. The weight ratio of textured protein to seasoning in the plant-based composition is from about 20:1 to about 2:1, from about 15:1 to about 2:1, from about 10:1 to about 2:1, from about 9:1 to about 2:1, from about 8:1 to about 2:1, from about 7:1 to about 2:1, from about 6:1 to about 2:1, from about 5:1 to about 2:1, from about 4:1 to about 2:1, or from about 3:1 to about 2:1. The plant-based food product maintains a commercially acceptable appearance, quality, and structure after hot holding at a temperature of from about 135° F. to about 212° F., from about 135° F. to about 200° F., from about 140° F. to about 200° F., from about 145° F. to about 200° F., from about 150° F. to about 200° F., from about 155° F. to about 200° F., from about 160° F. to about 200° F., from about 160° F. to about 195° F., from about 160° F. to about 190° F., from about 160° F. to about 185° F., or from about 160° F. to about 180° F. for a period of about 10 minutes or less, about 15 minutes or less, about 20 minutes or less, about 25 minutes or less, about 30 minutes or less, about 35 minutes or less, about 40 minutes or less, about 45 minutes or less, about 50 minutes or less, about 55 minutes or less, about 60 minutes or less, about 70 minutes or less, about 80 minutes or less, about 90 minutes or less, about 100 minutes or less, about 110 minutes or less, about 120 minutes or less, about 130 minutes or less, about 140 minutes or less, or about 150 minutes or less.

In certain embodiments of the methods of the first, second, and/or third aspects of the present invention, the plant-based food product can be compressed without disintegrating into a paste after cooking and hot holding for 60 min.

In certain embodiments of the methods of the first, second, and/or third aspects of the present invention, the plant-based food product can be stored in a refrigerator for 2 weeks with minimal water leaching out of the product, and retain its textural quality after reheating.

In certain embodiments of the methods of the first, second, and/or third aspects of the present invention, the plant-based food product can be stored in the freezer with minimal ice crystal formation and retention of its textural quality after reheating.

In a fourth aspect, the present invention is directed to a plant-based food product that includes a plant-based composition that includes a textured protein and seasoning. The weight ratio of textured protein to seasoning in the plant-based composition is from about 20:1 to about 2:1, from about 15:1 to about 2:1, from about 10:1 to about 2:1, from about 9:1 to about 2:1, from about 8:1 to about 2:1, from about 7:1 to about 2:1, from about 6:1 to about 2:1, from about 5:1 to about 2:1, from about 4:1 to about 2:1, or from about 3:1 to about 2:1. The plant-based food product maintains a commercially acceptable appearance, quality, and structure after hot holding at a temperature of from about 135° F. to about 212° F., from about 135° F. to about 200° F., from about 140° F. to about 200° F., from about 145° F. to about 200° F., from about 150° F. to about 200° F., from about 155° F. to about 200° F., from about 160° F. to about 200° F., from about 160° F. to about 195° F., from about 160° F. to about 190° F., from about 160° F. to about 185° F., or from about 160° F. to about 180° F. for a period of about 10 minutes or less, about 15 minutes or less, about 20 minutes or less, about 25 minutes or less, about 30 minutes or less, about 35 minutes or less, about 40 minutes or less, about 45 minutes or less, about 50 minutes or less, about 55 minutes or less, about 60 minutes or less, about 70 minutes or less, about 80 minutes or less, about 90 minutes or less, about 100 minutes or less, about 110 minutes or less, about 120 minutes or less, about 130 minutes or less, about 140 minutes or less, or about 150 minutes or less.

### BRIEF DESCRIPTION OF THE DRAWINGS

FIG. 1 illustrates the texture score results of Example 2.

FIG. 2a illustrates the average score for overall taste for both the pulled-pork and barbacoa flavors of Example 4.

FIG. 2b illustrates the average score for visuals for both the pulled-pork and barbacoa flavors of Example 4.

FIG. 2c illustrates the average score for overall aroma for both the pulled-pork and barbacoa flavors of Example 4.

FIG. 2d illustrates the average score for overall mouth feel for both the pulled-pork and barbacoa flavors of Example 4.

FIG. 3 represents the results of a survey of the dietary habits of the participants of Example 6.

FIG. 4a illustrates the overall rating of the chimichurri recipe evaluated in Example 6.

FIG. 4b illustrates the overall rating of the barbacoa recipe evaluated in Example 6.

FIG. 4c illustrates the overall rating of the tikka masala recipe evaluated in Example 6.

FIG. 4d illustrates the overall rating of the stroganoff recipe evaluated in Example 6.

FIG. 5 illustrates the results of the top two dishes selected by the participants in Example 6.

FIG. 6 represents the results of a survey of the dietary habits of the participants of Example 7.

FIG. 7a illustrates the overall rating of the chimichurri recipe evaluated in Example 7.

FIG. 7b illustrates the overall rating of the barbacoa recipe evaluated in Example 7.

FIG. 7c illustrates the overall rating of the tikka masala recipe evaluated in Example 7.

FIG. 7d illustrates the overall rating of the stroganoff recipe evaluated in Example 7.

FIG. 8 illustrates the results of the top two dishes selected by the participants in Example 7.

### DETAILED DESCRIPTION OF THE INVENTION

The benefits of utilizing and consuming a plant-based meat alternative compositions or plant-based meat alternative food products are numerous. The majority of plant-based proteins are produced such that they have a low impact on the use of land, water and energy resources, and result in lower carbon emissions.

The consumption of plant-based meat alternative compositions or plant-based meat alternative food products has been studied extensively. Diets higher in plant foods and lower in animal foods are associated with a lower risk of cardiovascular morbidity and mortality in the general population. Observational studies of vegetarians demonstrate that they exhibit a reduced risk for numerous chronic conditions, and recent research demonstrates that just small increases in plant protein intake can be associated with a reduced risk of death and disease. Plant-based proteins are also naturally free of contamination from growth hormones or antibiotics typically found in animal-derived proteins.

As used herein, the term “plant-based” corresponds to a component or product that comprises ingredients derived only from land or marine-based plants or fungi. The compounds within the original plant or fungi must be retained in a meaningful amount after processing. Plant-based sources include, for example, those from vegetables, fruits, grains/cereals, nuts, seeds, pulses/legumes, mushrooms, and algae.

The present invention is directed to plant-based compositions comprising a plant-based protein and a food seasoning. The present invention is further directed to methods of preparing a plant-based food product from the plant-based compositions described herein. The present invention is still further directed to methods of hot holding a plant-based food product which is prepared from the plant-based compositions described herein.

In one aspect, the present invention is directed to a plant-based dry composition comprising 2 parts of a textured protein comprising a textured pea protein and 0.5 part of seasoning. In one embodiment, the composition is a plant-based dry barbacoa composition and the seasoning is a barbacoa seasoning. In another embodiment, the composition is a plant-based dry chimichurri composition and the seasoning is a chimichurri seasoning. In a further embodiment, the composition is a plant-based dry tikka masala composition and the seasoning is a tikka masala seasoning. In another embodiment, the composition is a plant-based dry stroganoff composition and the seasoning is a stroganoff seasoning.

In a further aspect, the present invention is directed to a plant-based dry composition comprising 2 parts of a textured protein comprising a textured wheat protein and 0.5 part of seasoning. In one embodiment, the composition is a plant-based dry pulled pork BBQ composition and the seasoning is a pulled pork BBQ seasoning.

In still further aspects, the present invention is directed to methods for preparing a plant-based food product from the plant-based compositions described herein. In one embodiment, the method comprises mixing the contents of a plant-based dry composition for about 1 minute; combining the stirred composition and water for about 2 minutes to form a hydrated plant-based composition; and cooking the hydrated plant-based composition for about 6 minutes in a combi/steamer to form the plant-based food product. In another embodiment, the method comprises mixing the contents of a plant-based dry composition for about 1 minute; combining the stirred composition and water for about 2 minutes to form a hydrated plant-based composition; and cooking the hydrated plant-based composition for about 20 minutes in a convection, or 25 minutes in a standard oven to form the plant-based food product. In yet another embodiment, the method comprises pouring hot water, having a temperature from about 43° C. to about 85° C. on a plant-based dry composition and letting the product hydrate for from about 2 to about 7 min.

The plant-based compositions of the present invention generally comprises a plant-based meat alternative and certain seasonings. The plant-based meat alternative may comprise any suitable plant-based protein. For example, in one embodiment, the plant-based protein is a textured protein derived from wheat, corn, fungus, or other suitable plant sources. In another embodiment, the plant-based protein may be selected from the group consisting of pea protein, wheat protein, soy protein, chickpea protein, fava bean protein, lentil protein, corn protein, canola protein, other plant-based proteins and combinations thereof. In certain embodiments, the plant-based protein is selected from the group consisting of pea protein, wheat protein, and combinations thereof.

Pea protein is typically derived from yellow and/or green peas. The pea protein may also be derived from, for example, pea flour. The pea protein may be in the form of an isolate, a concentrate, flour, or in a textured form. When the pea protein is a textured pea protein, the textured pea protein may be in the form of crumbles, granules, strings, shreds, chips, or combinations thereof. In certain embodiments, the pea protein has a protein quality of 0.81 based on the in vitro Protein Digestibility Corrected Amino Acid Score (PDCAAS) value.

In one embodiment, the pea protein is in the form of a textured pea protein and the textured pea protein is produced by extrusion of pea protein isolate. In another embodiment, the textured pea protein is produced by extrusion of a mixture comprising a pea protein isolate and additives. The additives may be any component suitable for the formation of a textured pea protein. For example, the additives may be selected from the group consisting of starches or flour, sodium carbonate, mixed tocopherols, and combinations thereof. The starches or flour may be selected from, for example, tapioca, corn, pea, potato, and combinations thereof.

In certain embodiments, the pea protein comprises the textured pea protein PROTERRA 2100 (commercially available from MGP Ingredients, Inc.). PROTERRA 2100 is a textured pea protein in the form of dry crumbles or granules. PROTERRA 2100 typically comprises 60.4% protein, 3.3% fat, 1.7% total dietary fiber, and 374 calories per 100 g. The hydration capacity of PROTERRA 2100 is approximately 2.3 g/g.

Wheat protein is typically derived from gluten. The wheat protein may also be derived from, for example, wheat flour. The wheat protein is typically in the form of a textured wheat protein. When the wheat protein is a textured wheat protein, the textured wheat protein may be in the form of crumbles, granules, strings, shreds, chips, or combinations thereof.

In one embodiment, the wheat protein is a textured wheat protein that is produced by extrusion of wheat gluten, wheat starch, and additives. The additives may be any component suitable for the formation of a textured wheat protein. For example, the additives may be selected from the group consisting of tetrapotassium pyrophosphate, caramel color, sodium carbonate, mixed tocopherols, and combinations thereof. In certain embodiments, the textured wheat protein is produced by extrusion of a mixture comprising wheat gluten, wheat starch, wheat flour, tetrapotassium pyrophosphate, (or tetrasodium pyrophosphate), caramel color, sodium carbonate, and mixed tocopherols.

In one embodiment, the wheat protein comprises a textured wheat protein selected from the group consisting of PROTERRA 1200C, PROTERA 1200DC, and combinations thereof. PROTERRA 1200C (commercially available from MGP Ingredients, Inc.) is a shredded textured wheat protein formulation that is caramel colored and typically comprises 79.0% protein, 7.7% fat, 1.9% total dietary fiber, and 411 calories per 100 g. The hydration capacity of PROTERRA 1200C varies from about 3.5 to about 3.7 g/g. PROTERRA 1200DC (commercially available from MGP Ingredients, Inc.) is a shredded textured wheat protein that is dark caramel colored and typically comprises 61.4% protein, 4.3% fat, 0.8% total dietary fiber, and 372 calories per 100 g. The hydration capacity of PROTERRA 1200DC ranges from about 2.5 to about 2.7 g/g.

The seasoning(s) of plant-based composition of the present invention may include any suitable seasoning for forming a plant-based food product. The plant-based composition of the present invention may include a combination of seasonings to form a taste profile associated with a typical meat-based food product. For example, seasonings associated with the meat-based food products barbacoa, chimichurri, tikka masala, stroganoff, or pulled pork BBQ may be combined with the plant-based meat alternative to form the plant-based composition of the present invention.

Barbacoa seasonings typically comprise a blend of dehydrated onion and garlic, spices, yeast extract, maltodextrin, salt, smoked paprika, and natural flavors. Chimichurri seasonings typically comprise a blend of dehydrated garlic and onion, yeast extract, salt, spices, sugar, maltodextrin, lemon juice or lemon juice powder (maltodextrin, lemon juice concentrate), natural flavors, lime juice or lime juice powder (lime juice, maltodextrin), and citric acid. Tikka masala seasonings typically comprise a blend of dehydrated onion and garlic, yeast extract, tomato powder, salt, paprika, spices, maltodextrin, turmeric, natural flavors, lemon juice or lemon juice powder (maltodextrin, lemon juice concentrate), and modified corn starch. Stroganoff seasonings typically comprise a blend of dehydrated onion and garlic, salt, corn starch, dextrose, mushroom powder, sugar, yeast extract, spices, and natural flavors. Pulled pork BBQ seasonings typically comprise a blend of demerara cane sugar, dehydrated vegetables (e.g., tomato, onion, garlic), spices, maltodextrin, natural flavors, yeast extract, salt, smoke flavor, torula yeast, molasses, tapioca starch, paprika, and vinegar or vinegar powder (maltodextrin, white distilled vinegar). Each of the seasonings noted above may also comprise silicon dioxide as an anti-caking agent if necessary.

To form the plant-based composition of the present invention, the plant-based meat alternative comprising a suitable plant-based protein and the desired seasonings are combined in dry form. For example, the suitable plant-based protein and the desired seasonings may be combined in dry form in a weight ratio of plant-based protein to seasoning of from about 20:1 to about 2:1, from about 15:1 to about 2:1, from about 10:1 to about 2:1, from about 9:1 to about 2:1, from about 8:1 to about 2:1, from about 7:1 to about 2:1, from about 6:1 to about 2:1, from about 5:1 to about 2:1, from about 4:1 to about 2:1, or from about 3:1 to about 2:1 In one embodiment, about 2 parts of a plant-based meat alternative is combined with about 0.1, about 0.2, about 0.3, about 0.4, about 0.5, about 0.6, about 0.7, about 0.8, about 0.9 or about 1 parts of the desired seasoning. For example, in one embodiment, about 2 parts of a plant-based meat alternative is combined with about 0.5 parts of the desired seasoning. In another embodiment, about 2 parts of a plant-based meat alternative is combined with 0.7 parts of the desired seasoning.

In some embodiments, the plant-based composition is combined in an upright bag and sealed for future use. In this manner, “kits” of the plant-based composition can be prepared, shipped, and/or stored prior to hydration and formation of the ultimate plant-based food product.

To form the plant-based food product of the present invention, the plant-based composition comprising the plant-based meat alternative comprising a suitable plant-based protein and the desired seasonings is combined with water and oil. The addition of water and oil acts to hydrate the dry plant-based composition. The oil used in the hydration step may be any oil suitable for human consumption and cooking. For example, the oil may be selected from olive oil, palm oil, rice oil, vegetable oil (i.e. soybean oil), grape seed oil, and combinations thereof.

In one embodiment, 2.5 parts of the plant-based composition is combined with 10 cups of water and 1 cup of oil. In another embodiment, 2.5 parts of the plant-based composition is combined with 10 cups of water and 0.5 cups of oil.

The plant-based composition is allowed to hydrate for about 1, about 2, about 3, about 4, about 5, about 6, about 7, about 8, about 9, or about 10 minutes prior to cooking the hydrated composition. The hydrated composition is then cooked to achieve a desired internal temperature. The desired internal temperate of the cooked plant-based food product may be about 160° F. or greater, about 165° F. or greater, about 170° F. or greater, about 175° F. or greater, about 180° F. or greater, about 185° F. or greater, about 190° F. or greater, about 195° F. or greater, or about 200° F. or greater.

The hydrated composition may be cooked by any suitable cooking mechanism. For example, in one embodiment, the hydrated composition is cooked in a convection oven (CO). An example of a CO is a Viking model F20362B (M0706VR). In another embodiment, the hydrated composition is cooked in a standard oven (SO). An example of a SO is a Viking model F20362B (M0706VR). In still a further embodiment, the hydrated composition is cooked in a Combi steamer (CS). An example of a CS is a Henny Penny model LCS.

When utilising a CO, the hydrated composition is generally cooked at a temperature of from about 300° F. to about 450° F., from about 325° F. to about 450° F., from about 325° F. to about 425° F., from about 325° F. to about 400° F., from about 350° F. to about 400° F., or from about 350° F. to about 375° F. The hydrated composition is generally cooked in a CO for a time period of from about 5 minutes and about 30 minutes, from about 10 minutes and about 30 minutes, from about 10 minutes and about 25 minutes, from about 10 minutes and about 20 minutes, from about 10 minutes and about 14 minutes, from about 10 minutes and about 13 minutes, or from about 11 minutes and about 13 minutes. For example, in one embodiment, the hydrated composition is cooked in a CO at a temperature of from about 350° F. to about 375° F. for a time period of from about 10 to about 15 minutes.

When utilising a SO, the hydrated composition is generally cooked at a temperature of from about 300° F. to about 450° F., from about 325° F. to about 450° F., from about 350° F. to about 450° F., from about 350° F. to about 425° F., or from about 350° F. to about 400° F. The hydrated composition is generally cooked in a SO for a time period of from about 15 minutes and about 60 minutes, from about 15 minutes and about 55 minutes, from about 15 minutes and about 50 minutes, from about 15 minutes and about 45 minutes, from about 15 minutes and about 40 minutes, from about 15 minutes and about 45 minutes, from about 20 minutes and about 45 minutes, from about 25 minutes and about 45 minutes, from about 25 minutes and about 40 minutes, or from about 25 minutes and about 35 minutes. For example, in one embodiment, the hydrated composition is cooked in a SO at a temperature of about 375° F. for a time period of from about 20 to about 30 minutes.

When utilising a CS, the hydrated composition is generally cooked at a temperature of from about 150° F. to about 300° F., from about 175° F. to about 300° F., from about 200° F. to about 300° F., from about 200° F. to about 2750° F., from about 200° F. to about 250° F., from about 200° F. to about 225° F., or from about 210° F. to about 220° F. The hydrated composition is generally cooked in a CS for a time period of from about 1 minute to about 15 minutes, from about 1 minute to about 14 minutes, from about 1 minute to about 13 minutes, from about 1 minute to about 12 minutes, from about 1 minute to about 11 minutes, from about 1 minute to about 10 minutes, from about 2 minutes to about 10 minutes, from about 2 minutes to about 8 minutes, or from about 4 minutes to about 8 minutes. In one embodiment, the hydrated composition is cooked in a CS at a temperature of from about 212° F. to about 215° F. for a time period of from about 2 minutes to about 10 minutes. In certain embodiments, it may be desirable to cook the hydrated composition utilizing an uncovered CS.

As an alternative to cooking the hydrated composition (i.e. utilizing a CO, SO, or CS), in another embodiment, the plant-based composition is combined with hot water to “cook” the composition. For example, hot water with a temperature of about 40° C. or greater, about 42° C. or greater, about 44° C. or greater, about 46° C. or greater, about 48° C. or greater, about 50° C. or greater, about 52° C. or greater, about 54° C. or greater, about 56° C. or greater, about 58° C. or greater, or about 60° C. or greater. In another embodiment, the hot water has a temperature of about 75° C. or greater, about 80° C. or greater, about 85° C. or greater, about 90° C. or greater, or about 95° C. or greater. In this alternative method for preparing a plant-based food product, the combined plant-based composition and hot water is allowed to stand for about 1, about 2, about 3, about 4, about 5, about 6, about 7, about 8, about 9, or about 10 minutes prior to evaluating the food product for texture and appearance.

In certain embodiments wherein the plant-based food products of the present invention comprise a wheat protein, the below conditions may be utilized when cooking the hydrated composition.

| | Kitchen Equipment | | | | | |
|---|---|---|---|---|---|---|
| | Convection oven | | Standard oven | | Combi/steamer | |
| Temperature | 375° | F. | 375° | F. | 225° | F. |
| Cooking time | 15 | min | 25 | min | 3 | min |

| | | | |
|---|---|---|---|
| Pan covering | Covered | Covered | Uncovered |

In certain embodiments, wherein the plant-based food products of the present invention comprising a pea protein, the below conditions may be utilized when cooking the hydrated composition.

| | Kitchen Equipment | | | | | |
|---|---|---|---|---|---|---|
| | Convection oven | | Standard oven | | Combi/steamer | |
| Temperature | 375° | F. | 375° | F. | 225° | F. |
| Cooking time | 15-20 | min | 25 | min | 6 | min |

| | | | |
|---|---|---|---|
| Pan covering | Covered | Covered | Uncovered |

In a particular embodiment of the present invention, a method for preparing a plant-based food product from a plant-based dry composition as described herein comprises: mixing the contents of the plant-based dry composition for about 1 minute; combining the stirred composition and water for about 2 minutes to form a hydrated plant-based composition; and cooking the hydrated plant-based composition for about 6 minutes in a combi/steamer to form the plant-based food product.

In another embodiment, a method for preparing a plant-based food product from a plant-based dry composition as described herein comprises: mixing the contents of the plant-based dry composition for about 1 minute; combining the stirred composition and water for about 2 minutes to form a hydrated plant-based composition; and cooking the hydrated plant-based composition for about 20 minutes in a convection oven, or 25 min in a standard oven to form the plant-based food product.

In the food industry, particularly in commercial settings (e.g., cafeterias, buffets, etc.), it is common to prepare hot food products and maintain their temperature in a steamer/food warmer or other heating apparatus. This is generally termed “hot holding” of the food product. Traditionally, plant-based food products encountered issues when subjected to hot holding for an extended period of time. For example, the plant-based food product may change appearance or the quality and structure of the plant-based food product may deteriorate to an unacceptable extent. One surprising and advantageous aspect of the plant-based food products of the present invention is the ability of such food products to withstand “hot holding” for an extended period of time while maintaining commercially acceptable appearance, quality, and structure.

In one aspect of the present invention, the plant-based food products of the present invention may maintain commercially acceptable appearance, quality, and structure after hot holding for a period of about 10 minutes or less, about 15 minutes or less, about 20 minutes or less, about 25 minutes or less, about 30 minutes or less, about 35 minutes or less, about 40 minutes or less, about 45 minutes or less, about 50 minutes or less, about 55 minutes or less, about 60 minutes or less, about 70 minutes or less, about 80 minutes or less, about 90 minutes or less, about 100 minutes or less, about 110 minutes or less, about 120 minutes or less, about 130 minutes or less, about 140 minutes or less, or about 150 minutes or less. Plant-based food products of the present invention were found to be commercially stable and exhibit acceptable appearance, quality, and structure after steam table/buffet line hot holding at temperatures of from about 135° F. to about 212° F., from about 135° F. to about 200° F., from about 140° F. to about 200° F., from about 145° F. to about 200° F., from about 150° F. to about 200° F., from about 155° F. to about 200° F., from about 160° F. to about 200° F., from about 160° F. to about 195° F., from about 160° F. to about 190° F., from about 160° F. to about 185° F., or from about 160° F. to about 180° F. for a period of two hours or more. When utilizing an oven for hot holding, the plant-based food products of the present invention were found to be commercially stable and exhibit acceptable appearance, quality, and structure after hot holding at a temperature of from about 135° F. to about 212° F., from about 135° F. to about 200° F., from about 140° F. to about 200° F., from about 145° F. to about 200° F., from about 150° F. to about 200° F., from about 155° F. to about 200° F., from about 160° F. to about 200° F., from about 160° F. to about 195° F., from about 160° F. to about 190° F., from about 160° F. to about 185° F., or from about 160° F. to about 180° F. for a period of two hours or more. In certain embodiments, the hot holding temperature is 180° F. or less for a period of two hours or more. During hot holding, the contents of the steam table/buffet line were typically kept uncovered and the contents of the oven used for hot holding were covered. In each instance, the contents being held at an elevated temperature may be stirred occasionally. In one aspect of the present invention, the plant-based food products of the present invention may maintain commercially acceptable appearance, quality, and structure after hot holding for a period of about 10 minutes or less, about 15 minutes or less, about 20 minutes or less, about 25 minutes or less, about 30 minutes or less, about 35 minutes or less, about 40 minutes or less, about 45 minutes or less, about 50 minutes or less, about 55 minutes or less, about 60 minutes or less, about 70 minutes or less, about 80 minutes or less, about 90 minutes or less, about 100 minutes or less, about 110 minutes or less, about 120 minutes or less, about 130 minutes or less, about 140 minutes or less, or about 150 minutes or less.

In one aspect of the present invention, the plant-based food products of the present invention may maintain commercially acceptable appearance, quality, and structure after hot holding for a period of about 10 minutes or less, about 15 minutes or less, about 20 minutes or less, about 25 minutes or less, about 30 minutes or less, about 35 minutes or less, about 40 minutes or less, about 45 minutes or less, about 50 minutes or less, about 55 minutes or less, about 60 minutes or less, about 70 minutes or less, about 80 minutes or less, about 90 minutes or less, about 100 minutes or less, about 110 minutes or less, about 120 minutes or less, about 130 minutes or less, about 140 minutes or less, or about 150 minutes or less. Plant-based food products of the present invention were found to be commercially stable and exhibit acceptable appearance, quality, and structure after steam table/buffet line hot holding at temperatures of up to about 180° F. for a period of two hours or more. During hot holding, the contents of the steam table/buffet line were typically kept uncovered and the contents of the oven used for hot holding were covered. In each instance, the contents being held at an elevated temperature may be stirred occasionally.

Plant-based food products that are hot held may be further evaluated for suitability by, for example, compressing the food product to determine if the food product disintegrates. Plant-based food products of the present invention may be compressed after about 15 minutes, about 20 minutes, about 25 minutes, about 30 minutes, about 32 minutes, about 40 minutes, about 45 minutes, about 50 minutes, about 55 minutes, about 60 minutes, about 65 minutes, about 70 minutes, or about 75 minutes of hot holding and generally do not disintegrate into a paste upon compression.

Similarly, storage of plant-based food products has traditionally been difficult due to water leaching from the product over time and/or syneresis. Surprisingly, plant-based food products and/or plant-based compositions comprising the plant-based protein of the present invention exhibit satisfactory performance after cold-storage (e.g., refrigerator or freezer storage). For example, the plant-based food products and/or plant-based compositions of the present invention may be satisfactorily stored in a refrigerator (i.e. at a temperature of about 40° F.) for a period of about 1 day or more, about 2 days or more, about 3 days or more, about 4 days or more, about 5 days or more, about 6 days or more, about 1 week or more, about 2 weeks or more, about 3 weeks or more, or about 4 weeks or more. In another embodiment, the plant-based food products and/or plant-based compositions of the present invention may be satisfactorily stored in a freezer (i.e. at a temperature of about 0° F.) for a period of about 1 day or more, about 2 days or more, about 3 days or more, about 4 days or more, about 5 days or more, about 6 days or more, about 1 week or more, about 2 weeks or more, about 3 weeks or more, or about 4 weeks or more. Satisfactory cold storage in the context of the present invention is storage such that, after reheating to a temperature suitable for serving, the plant-based food products and/or plant-based compositions exhibit commercially acceptable appearance, quality, and structure. Typically, during such satisfactory storage, the appearance and structure of the food product or composition remains relatively unchanged and the formation of ice crystals is minimal.

The plant-based food products of the present invention may be used in a variety of recipes. For example, the plant-based food of the present invention could be used as a meat-substitute in a dish selected from the group consisting of a breakfast torta dish, pupusa dish, street taco dish, crispy roll dish, rice bowl dish, or stuffed pepper dish.

In certain embodiments, the nutritional value of the plant-based composition of the present invention may comprise about 11 g of protein, about 1 g of fat, about 1 g of fiber, and about 70 calories per serving size of about 18 g (14 cup).

### EXAMPLES

### Example 1

A series of experiments were conducted to identify suitable cooking parameters for plant-based meat substitute products. Pea-based proteins (e.g., ProTerra 2100) and wheat-based textured proteins (e.g., ProTerra 1200C) were evaluated without the addition of any seasoning to determine the suitability of plant-based meat substitutes produced at varying conditions.

Table 1 below sets forth a series of tests and includes the testing parameters. The pea-based or wheat-based textured proteins were combined with the water and oil in a container and cooked using either a convection oven “CO” (e.g., Viking model F20362B (M0706VR)), standard oven “SO” (e.g., Viking model F20362B (M0706VR)), or Combi steamer “CS” (e.g., Henny Penny model LCS).

The texture of the resulting plant-based meat substitutes were ranked on a scale of 1 to 5. A score of 1 indicates that most pieces had mushy texture and were generally too soft and broke apart. A score of 2 indicates that most pieces were mushy, but there were some firmer pieces present. A score of 3 indicates that most pieces were soft but not mushy or chewy. A score of 3 was determined to be the optimum texture. A score of 4 indicates that most pieces were chewy, but there were some softer pieces present. A score of 5 indicates that most pieces had a chewy and tough texture.

TABLE 1

| | | Textured | | | Hydration | Cook | Cook | Internal | Texture | |
|---|---|---|---|---|---|---|---|---|---|---|
| | Textured | Proteins | Water | Oil | Time | time | Temp | Temp | Score | |
| Equip. | Proteins | (lbs) | (cup) | (cup) | (min) | (min) | (° F.) | (° F.) | (1-5) | Notes |
| SO | Pea | 2 | 10 | 0.5 | 2 | 25 | 375 | 165 | 3.5 | |
| SO | Pea | 2 | 10 | 0.5 | 2 | 25 | 375 | 167 | 3.5 | |
| SO | Pea | 2 | 10 | 0.5 | 2 | 25 | 375 | 175 | 3 | |
| SO | Wheat | 2 | 6 | 2 | None | 20 | 375 | 161 | 2.5-3 | |
| SO | Wheat | 2 | 6 | 2 | None | 30 | 375 | 184 | 2 | |
| | | | | | | | | | (appeared | |
| | | | | | | | | | dry) | |
| SO | Wheat | 2 | 6 | 2 | None | 30 | 375 | 154 | 3.5 | |
| SO | Wheat | 2 | 6 | 2 | None | 20 | 350 | 142 | 3 | |
| SO | Wheat | 2 | 6 | 2 | None | 30 | 375 | 145 | 3 | |
| SO | Wheat | 2 | 6 | 2 | None | 25 | 350 | 174 | 3 | |
| SO | Wheat | 2 | 6 | 2 | None | 20 | 375 | 176 | 3 | |
| SO | Wheat | 2 | 6 | 2 | None | 25 | 375 | 186 | 2.5 | |
| SO | Wheat | 2 | 6 | 2 | None | 30 | 375 | 194 | 2 | |
| CO | Pea | 2 | 9.5 | 0.5 | 2 | 15 | 350 | 167 | 3 | |
| CO | Pea | 2 | 9.5 | 0.5 | 2 | 15 | 375 | 168 | 3 | |
| CO | Pea | 2 | 9.5 | 0.5 | 1 | 15 | 375 | 169 | 3 | |
| CO | Pea | 2 | 9.5 | 0.5 | 5 | 15 | 350 | 155 | 2.5 | |
| CO | Wheat | 1 | 1.5 | 2 | None | 10 | 375 | 171 | 5 - | |
| | | | | | | | | | Portions | |
| | | | | | | | | | raw | |
| CO | Wheat | 2 | 6 | 2 | None | 12 | 375 | 163 | 4 to 5 | |
| CO | Wheat | 2 | 5 | 2 | None | 15 | 375 | 163 | 4 | |
| | | | | | | | | | (Portions | |
| | | | | | | | | | hard) | |
| CO | Wheat | 2 | 3 | 2 | None | 10 | 375 | 156 | 4 - | |
| | | | | | | | | | Portions | |
| | | | | | | | | | raw | |
| CO | Wheat | 2 | 4 | 2 | None | 10 | 375 | 163 | 3.5 | |
| CO | Wheat | 2 | 6 | 1.5 | None | 15 | 375 | 168 | 3 | |
| | | | | | | | | | (Looked | |
| | | | | | | | | | dry) | |
| CO | Wheat | 2 | 6 | 2 | None | 10 | 375 | 153 | 3 | |
| CO | Wheat | 2 | 6 | 2 | None | 15 | 375 | 167 | 3 | |
| CO | Wheat | 2 | 8 | 1 | None | 15 | 375 | 168 | 2 | |
| CO | Wheat | 1 | 4 | 1 | 1 | 15 | 375 | 152 | 1 | |
| CS | Pea | 2 | 10 | 0.5 | 1 | 6 | 212 | 167 | 3-2.75 | Uncovered |
| CS | Pea | 2 | 10 | 0.5 | None | 6 | 212 | 167 | 3 | Uncovered |
| CS | Pea | 2 | 10 | 0.5 | None | 7 | 212 | 170 | 3 | Uncovered |
| CS | Wheat | 2 | 6 | 2 | None | 10 | 215 | 191 | 3-2.5 | Covered, |
| | | | | | | | | | | poked 6 |
| | | | | | | | | | | holes on |
| | | | | | | | | | | foil |
| CS | Wheat | 2 | 4 | 2 | None | 3 | 215 | 174 | 3.5 | Covered, |
| | | | | | | | | | (Looked | poked 6 |
| | | | | | | | | | dry) | holes on |
| | | | | | | | | | | foil |
| CS | Wheat | 2 | 4 | 2 | None | 4 | 215 | 178 | 3 | Covered, |
| | | | | | | | | | (Looked | poked 6 |
| | | | | | | | | | dry) | holes on |
| | | | | | | | | | | foil |
| CS | Wheat | 2 | 6 | 2 | None | 3 | 215 | 145 | 4 | Covered, |
| | | | | | | | | | | poked 6 |
| | | | | | | | | | | holes on |
| | | | | | | | | | | foil |
| CS | Wheat | 2 | 6 | 2 | None | 10 | 215 | 165 | 4 | Covered, |
| | | | | | | | | | | poked 6 |
| | | | | | | | | | | holes on |
| | | | | | | | | | | foil |
| CS | Wheat | 2 | 6 | 2 | None | 3 | 215 | 162 | 3 | Covered, |
| | | | | | | | | | | poked 6 |
| | | | | | | | | | | holes on |
| | | | | | | | | | | foil |
| CS | Wheat | 2 | 6 | 2 | None | 6 | 215 | 163 | 3 | Covered, |
| | | | | | | | | | | poked 6 |
| | | | | | | | | | | holes on |
| | | | | | | | | | | foil |
| CS | Wheat | 2 | 6 | 2 | None | 6 | 215 | 167 | 3 | covered, |
| | | | | | | | | | | poked 6 |
| | | | | | | | | | | holes on |
| | | | | | | | | | | foil |

Textured wheat protein generally required 6 cups of water and no hydration time, while textured pea protein general required 10 cups of water and 2 min of hydration time. Oil addition did not appear to affect the texture score. The best cooking procedures for textured wheat and textured pea proteins were similar, except that the textured pea required an additional 3 min on the CS.

A hot water cooking test “HW” was also conducted wherein hot water was poured onto a textured pea protein, the mixture was allowed to stand for a certain period of time, and the resulting product was evaluated for texture and appearance. The results of this experiment and the testing parameters are set forth below in Table 2.

TABLE 2

| | Water Temperature | | |
|---|---|---|---|
| Test | (° F.) | Standing Time (min) | Texture Score |
| HW-1 | 185° F. | 2 | 2.5 |
| | | 5 | 2.5 |
| | | 7 | 2.5 |
| HW-2 | 130° F. | 2 | 3.5 |
| | | 5 | 3 |
| | | 7 | 2.5 |
| HW-3 | 110° F. | 2 | 4 |
| | | 5 | 3 |
| | | 7 | 3 |

It was noted that as the sample gets cold, all samples had similar texture with the score between 3-3.5, and the HW method produced fillings with less flavor and aroma intensity (less “cooked” note) than oven, stovetop or steamer methods presented in Table 1.

### Example 2: Hot-Holding

To simulate stress on plant-based wheat, pea, and soy textured proteins, the proteins were subjected to hot-holding trials for a period of time. The plant-based textured proteins were originally cooked by a device selected from a convection oven “CO,” standard oven “SO,” or Combi steamer “CS.” The plant-based textured proteins were then maintained at an elevated temperature by hot holding procedures comprising either a Steamer/Food Warmer “SF” or a Standard Oven “SO.” Additionally, the Steamer/Food Warmer was either covered (i.e. with a lid affixed) or uncovered (i.e. with no lid). The intent of this test was to determine how long the plant-based textured proteins would maintain a suitable form when held on a buffet line (i.e. steamer/food warmer) or in an oven for an extended period of time. The results of this experiment are set forth below in Tables 4-6.

All prepared products scored 3 (optimal) at 30 min. The products were evaluated for appearance and texture scoring at every 30 min increment, and the evaluation stopped when the product scored below 3, or the unacceptable appearance were noted.

The textured proteins tested in this experiment are as set forth below in Table 3.

TABLE 3

| Name | Textured Protein |
|---|---|
| Wheat 1 | ProTerra 1200C (commercially available |
| | from MGP Ingredients): Wheat Gluten, |
| | Wheat Starch, Tetrapotassium |
| | Pyrophosphate, Caramel Color, Sodium |
| | Carbonate, and Mixed tocopherols |
| Wheat 2 | ProTerra 1200DC (commercially available |
| | from MGP Ingredients): wheat gluten, |
| | wheat starch, caramel color, |
| | tetrapotassium pyrophosphate, sodium |
| | carbonate, and mixed tocopherols |
| Soy 1 | WinCrest Bulk Foods: textured soy flour |
| Soy 2 | Druids Grove (commercially available |
| | from Modernist Pastry): soy protein |
| | concentrate |
| Pea 1 | ProTerra 2100 (commercially available |
| | from MGP Ingredients): pea protein |
| | isolate, tapioca starch, sodium carbonate, |
| | mixed tocopherols |
| Pea 2 | Plant Boss (commercially available from |
| | Frontier Co-op): organic textured pea |
| | protein. |
| Pea 3 | Noble Plate Pea: pea protein |

Pea 2 is said to have a nutritional value per 1 cup of dry product (46 g) of 180 calories, 3 g fat, 340 mg sodium, 2 g Total Carbohydrate, 2 g dietary fiber, and 36 g protein.

Pea 3 is said to have a nutritional value per 1 cup of product (56 g) of 220 calories, 3.5 g fat, 420 mg sodium, 2 g Total Carbohydrate 2 g Dietary fiber, and 45 g protein.

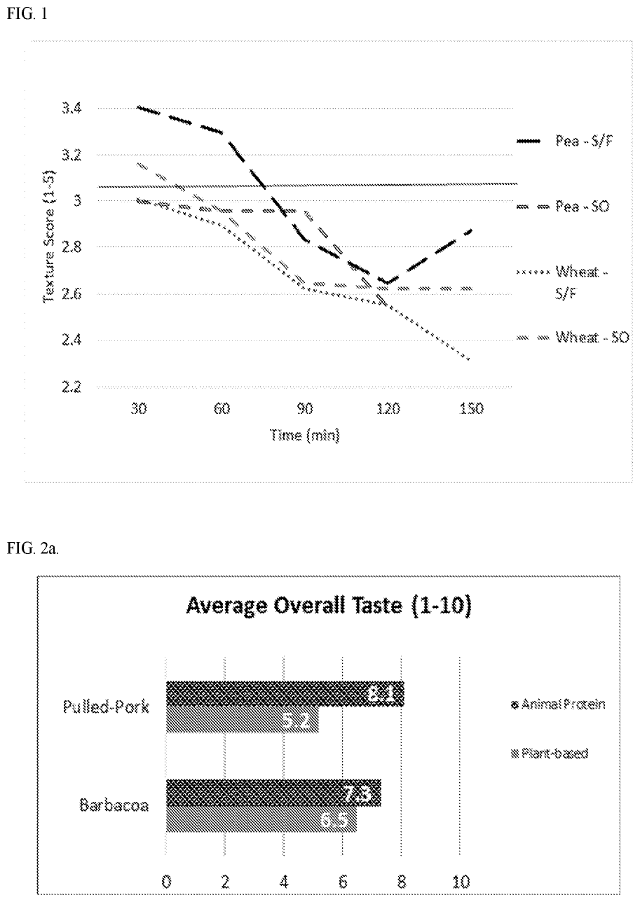

The results of this experiment are set forth below in Tables 4-6 and are shown graphically in FIG. 1.

TABLE 4

| | | | | | | Internal | | |
|---|---|---|---|---|---|---|---|---|
| | Textured | Cooking | Holding | Lid | Time | Temp | | |
| Trial | proteins | method | method | covering | (min) | (° F.) | Appearance | Score |
| 1 | Wheat 1 | CO | S/F | Covered | 30 | 172 | Moist, crusty side | 3 |
| 1 | Wheat 1 | CO | S/F | Covered | 60 | 173 | Moist crusty side, | 3 |
| | | | | | | | bottom | |
| 1 | Wheat 1 | CO | S/F | Covered | 90 | 172 | Moist, crusty side, | 3.5 |
| | | | | | | | bottom | |
| 1 | Wheat 1 | CO | S/F | Covered | 120 | 160 | Moist, crusty side, | 3.5 |
| | | | | | | | bottom | |
| 1 | Wheat 1 | CO | S/F | Covered | 150 | 155 | Mushy and crusty | 2 |
| | | | | | | | sides | |
| 1 | Wheat 1 | CO | S/F | Covered | 180 | 153 | Mushy and crusty | 2 |
| | | | | | | | sides | |
| 2 | Wheat 1 | CO | SO | Covered | 30 | 153 | Moist, not crusty | 3 |
| 2 | Wheat 1 | CO | SO | Covered | 60 | 159 | Moist not crusty | 3 |
| 2 | Wheat 1 | CO | SO | Covered | 90 | 162 | Moist, not crusty | 3 |
| 2 | Wheat 1 | CO | SO | Covered | 120 | 166 | Moist, not crusty | 3 |
| 2 | Wheat 1 | CO | SO | Covered | 150 | 167 | Moist, not crusty | 2.75 |
| 2 | Wheat 1 | CO | SO | Covered | 180 | 165 | Moist, not crusty | 2.75 |
| 3 | Wheat 1 | CO | S/F | Uncovered | 30 | 164 | Crust forming | 3 |
| 3 | Wheat 1 | CO | S/F | Uncovered | 60 | 166 | Moist crusty | 3 |
| 3 | Wheat 1 | CO | S/F | Uncovered | 90 | 162 | Top dry, crusty | 2.875 |
| 3 | Wheat 1 | CO | S/F | Uncovered | 120 | 152 | Top dry, crusty | 2.75 |
| 3 | Wheat 1 | CO | S/F | Uncovered | 150 | 151 | Top dry, crusty | 2.5 |
| 3 | Wheat 1 | CO | S/F | Uncovered | 180 | 151 | Top dry, crusty | 2 |
| 4 | Wheat 1 | CO | SO | Uncovered | 30 | 175 | Very dry and crusty | 4 |
| 4 | Wheat 1 | SO | S/F | Covered | 30 | 167 | Sticky bottom | 3 |
| 4 | Wheat 1 | SO | S/F | Covered | 60 | 157 | Same, some soft | 2.875 |
| 4 | Wheat 1 | SO | S/F | Covered | 90 | 151 | Same, same | 2.875 |
| 4 | Wheat 1 | SO | S/F | Covered | 120 | 145 | Less sticky, more | 2.75 |
| | | | | | | | mushy | |
| 4 | Wheat 1 | SO | S/F | Covered | 150 | 145 | Same, same | 2 |
| 5 | Wheat 1 | SO | SO | Covered | 30 | 160 | Moist, no crust | 3.25 |
| 5 | Wheat 1 | SO | SO | Covered | 60 | 159 | Same | 3 |
| 5 | Wheat 1 | SO | SO | Covered | 90 | 158 | Same | 2.875 |
| 5 | Wheat 1 | SO | SO | Covered | 120 | 154 | Same | 2.875 |
| 5 | Wheat 1 | SO | SO | Covered | 150 | 157 | Same | 2.5 |
| 6 | Wheat 1 | SO | S/F | Uncovered | 30 | 162 | Surface dry, crusty | 3.25 |
| 6 | Wheat 1 | SO | S/F | Uncovered | 60 | 151 | Same, bottom sticky | 2.75 |
| 6 | Wheat 1 | SO | S/F | Uncovered | 90 | 150 | Crusty top, mushy | 2.5 |
| 6 | Wheat 1 | SO | S/F | Uncovered | 120 | 141 | Same, dry | 2 |
| 6 | Wheat 1 | SO | S/F | Uncovered | 150 | 154 | Very dry, spongy | toss |
| 7 | Wheat 1 | CS | S/F | Covered | 30 | 177 | Moist, Crusty sides | 2.75-3 |
| 7 | Wheat 1 | CS | S/F | Covered | 60 | 171 | Mushy | 2-1.5 |
| 7 | Wheat 1 | CS | S/F | Covered | 90 | 173 | Mushy | 2 |
| 8 | Wheat 1 | CS | SO | Covered | 30 | 171 | Moist, mushy | 2.875 |
| | | | | | | | bottom | |
| 8 | Wheat 1 | CS | SO | Covered | 60 | 160 | Moist, mushy | 3 |
| | | | | | | | bottom | |
| 8 | Wheat 1 | CS | SO | Covered | 90 | 160 | Moist, mushy | 2 |
| 9 | Wheat 1 | CS | S/F | Uncovered | 30 | 167 | Top dry, moist | 2.875 |
| 9 | Wheat 1 | CS | S/F | Uncovered | 60 | 161 | Top dry, crusty top | 3 |
| | | | | | | | side | |
| 9 | Wheat 1 | CS | S/F | Uncovered | 90 | 151 | Top dry, crusty top | 2 |
| | | | | | | | side | |

TABLE 5

| | | | | | | Internal | | |
|---|---|---|---|---|---|---|---|---|
| | Textured | Cooking | Holding | Lid | Time | Temp | | |
| Trial | proteins | method | method | covering | (min) | (° F.) | Appearance | Score |
| 10 | Wheat 2 | CO | S/F | Covered | 30 | 164 | Some dry bits on | 3 |
| | | | | | | | top | |
| 10 | Wheat 2 | CO | S/F | Covered | 60 | 154 | Caking bottom, | 3 |
| | | | | | | | moist | |
| 10 | Wheat 2 | CO | S/F | Covered | 90 | 150 | Moist | 2.5 |
| 10 | Wheat 2 | CO | S/F | Covered | 120 | 149 | Very moist, | 2.5 |
| | | | | | | | spongy | |
| 11 | Wheat 2 | CO | SO | Covered | 30 | 167 | Servable quality | 3 |
| 11 | Wheat 2 | CO | SO | Covered | 60 | 156 | Moist | 3 |
| 11 | Wheat 2 | CO | SO | Covered | 90 | 156 | Moist | 2.75 |
| 11 | Wheat 2 | CO | SO | Covered | 120 | 149 | Turning spongy | 2.25 |
| 12 | Wheat 2 | CO | S/F | Uncovered | 30 | 175 | Some dry bits, | 3 |
| | | | | | | | moist | |
| 12 | Wheat 2 | CO | S/F | Uncovered | 60 | 170 | Very dry top | 3 |
| 12 | Wheat 2 | CO | S/F | Uncovered | 90 | 164 | Same, moist | 2.75 |
| 12 | Wheat 2 | CO | S/F | Uncovered | 120 | 155 | Same, moist | 3 |
| 13 | Wheat 2 | CO | S/F | Covered | 30 | 161 | Optimal | 3 |
| 13 | Wheat 2 | CO | S/F | Covered | 60 | 167 | Dry top, moist, | 2.75 |
| | | | | | | | some spongy | |
| 13 | Wheat 2 | CO | S/F | Covered | 90 | 158 | Spongy | 2.5 |
| 13 | Wheat 2 | CO | S/F | Covered | 120 | 162 | Spongy | 2.25 |
| 14 | Wheat 2 | CO | SO | Covered | 30 | 161 | Caking bottom | 3 |
| 14 | Wheat 2 | CO | SO | Covered | 60 | 160 | Moist, some | 2.75 |
| | | | | | | | spongy | |
| 14 | Wheat 2 | CO | SO | Covered | 90 | 160 | Spongy | 2.75 |
| 14 | Wheat 2 | CO | SO | Covered | 120 | 157 | Spongy | 2.5 |
| 15 | Wheat 2 | CO | S/F | Uncovered | 30 | 166 | Dry top, some | 3 |
| | | | | | | | caking | |
| 15 | Wheat 2 | CO | S/F | Uncovered | 60 | 174 | Crusty side, dry | 3 |
| | | | | | | | top | |
| 15 | Wheat 2 | CO | S/F | Uncovered | 90 | 167 | Spongy | 2.5 |
| 15 | Wheat 2 | CO | S/F | Uncovered | 120 | 160 | Spongy | 2 |
| 16 | Wheat 2 | CS | S/F | Covered | 30 | 173 | Moist center, dry | 3 |
| | | | | | | | top | |
| 16 | Wheat 2 | CS | S/F | Covered | 60 | 171 | Same, caking | 2.5 |
| | | | | | | | bottom | |
| 16 | Wheat 2 | CS | S/F | Covered | 90 | 162 | Same, same | 2.5 |
| 16 | Wheat 2 | CS | S/F | Covered | 120 | 154 | Same, same | 2 |
| 17 | Wheat 2 | CS | SO | Covered | 30 | 168 | Moist | 3 |
| 17 | Wheat 2 | CS | SO | Covered | 60 | 167 | Moist | 3 |
| 17 | Wheat 2 | CS | SO | Covered | 90 | 160 | Moist, spongy | 2.5 |
| | | | | | | | bottom | |
| 17 | Wheat 2 | CS | SO | Covered | 120 | 145 | Moist, spongy | 2.5 |
| | | | | | | | bottom | |
| 18 | Wheat 2 | CS | S/F | Uncovered | 30 | 164 | Very dry surface | 3 |
| 18 | Wheat 2 | CS | S/F | Uncovered | 60 | 160 | Same, some hard | 3 |
| | | | | | | | bits | |
| 18 | Wheat 2 | CS | S/F | Uncovered | 90 | 159 | Dry top | 3 |
| 18 | Wheat 2 | CS | S/F | Uncovered | 120 | 150 | Same, some hard | 2.75 |
| | | | | | | | bits | |
| 18 | Wheat 2 | CS | S/F | Uncovered | 150 | 140 | Same | 2.75 |

TABLE 6

| | | | | | | Internal | | |
|---|---|---|---|---|---|---|---|---|
| | Textured | Cooking | Holding | Lid | Time | Temp | | |
| Trial | proteins | method | method | covering | (min) | (° F.) | Appearance | Score |
| 19 | Pea 1 | SO | S/F | Covered | 30 | 175 | | 3 |
| 19 | Pea 1 | SO | S/F | Covered | 60 | 182 | | 2.5 |
| 19 | Pea 1 | SO | S/F | Covered | 90 | 177 | Moist | 2.75 |
| 19 | Pea 1 | SO | S/F | Covered | 120 | 170 | | 2 |
| 20 | Pea 1 | SO | S/F | Uncovered | 30 | 165 | | 3 |
| 20 | Pea 1 | SO | S/F | Uncovered | 60 | 170 | Very moist | 3 |
| 20 | Pea 1 | SO | S/F | Uncovered | 90 | 171 | Less moist | 2.75 |
| 20 | Pea 1 | SO | S/F | Uncovered | 120 | 170 | Very little | 2.875 |
| | | | | | | | change in | |
| | | | | | | | texture | |
| 20 | Pea 1 | SO | S/F | Uncovered | 150 | | Dry on top | |
| 21 | Pea 1 | SO | SO | Covered | 30 | 165 | | 3 |
| 21 | Pea 1 | SO | SO | Covered | 60 | 167 | Caking on | 3 |
| | | | | | | | bottom | |
| 21 | Pea 1 | SO | SO | Covered | 90 | 156 | | 3 |
| 21 | Pea 1 | SO | SO | Covered | 120 | 155 | | 2.75 |
| 22 | Pea 1 | CO | S/F | Covered | 30 | 162 | Caking on | 3.25 |
| | | | | | | | bottom | |
| 22 | Pea 1 | CO | S/F | Covered | 60 | 155 | Moist, still good | 3 |
| 22 | Pea 1 | CO | S/F | Covered | 90 | 155 | Very moist | 2.75 |
| 22 | Pea 1 | CO | S/F | Covered | 120 | 167 | Moist, still good | 2.75 |
| | | | | | | | texture | |
| 22 | Pea 1 | CO | S/F | Covered | 150 | 142 | Less moist | 2.5 |
| 23 | Pea 1 | CO | S/F | Uncovered | 30 | 162 | Moist | 3 |
| 23 | Pea 1 | CO | S/F | Uncovered | 60 | 158 | Moist, good | 3 |
| | | | | | | | texture | |
| 23 | Pea 1 | CO | S/F | Uncovered | 90 | 157 | Not as moist | 3.5 |
| 23 | Pea 1 | CO | S/F | Uncovered | 120 | 158 | Not dry, but less | 3 |
| | | | | | | | moist | |
| 23 | Pea 1 | CO | S/F | Uncovered | 150 | 145 | Same | 3 |
| 24 | Pea 1 | CO | SO | Covered | 30 | 167 | Moist | 3 |
| 24 | Pea 1 | CO | SO | Covered | 60 | 155 | Moist | 3 |
| 24 | Pea 1 | CO | SO | Covered | 90 | 145 | Not as moist | 3 |
| 24 | Pea 1 | CO | SO | Covered | 120 | 144 | Same | 2 |
| 25 | Pea 1 | CS | S/F | Covered | 30 | 175 | Moist | 3 |
| 25 | Pea 1 | CS | S/F | Covered | 60 | 178 | Moist | 2.875 |
| 25 | Pea 1 | CS | S/F | Covered | 90 | 180 | Soggy bottom | 2.25 |
| 25 | Pea 1 | CS | S/F | Covered | 120 | 175 | Very wet | 2.25 |
| 25 | Pea 1 | CS | S/F | Covered | 150 | 168 | Very wet | 2.5 |
| 26 | Pea 1 | CS | S/F | Uncovered | 30 | 174 | Dry top | 3 |
| 26 | Pea 1 | CS | S/F | Uncovered | 60 | 174 | Dry top | 3 |
| 26 | Pea 1 | CS | S/F | Uncovered | 90 | 176 | Dry top | 3 |
| 26 | Pea 1 | CS | S/F | Uncovered | 120 | 175 | Dry top | 3 |
| 26 | Pea 1 | CS | S/F | Uncovered | 150 | 170 | Dry top | 3.5 |
| 27 | Pea 1 | CS | SO | Covered | 30 | 158 | Good, moist | 3 |
| 27 | Pea 1 | CS | SO | Covered | 60 | 155 | Moist | 2.875 |
| 27 | Pea 1 | CS | SO | Covered | 90 | 160 | Moist | 2.875 |
| 27 | Pea 1 | CS | SO | Covered | 120 | 161 | Moist | 2.875 |

As the fillings were held at hot temperatures, the texture scores decreased with time, indicating that the product became softer and exhibited a “mushier” texture. When the fillings from textured wheat, pea, or soy proteins were compared, textured pea protein had the slowest rate of softening.

It was determined that both a steamer/food warmer and standard oven could be used to hold the plant-based textured proteins for 2 hours. While two hours is said to be the recommended holding time for food safety, it was determined that the textured pea protein could be held in the food warmer for periods in excess of 2 hours (trial 23, 25-27).

### Example 3: Compression and Cold Testing

A Compression test was further conducted after the plant-based textured proteins were held on a steam table for 60 minutes. Samples were compressed between a flat-bottom glass and a plate, and turned five times by hand. It was noted whether the samples disintegrated after the compression. The results are set forth below in Table 7.

TABLE 7

| | | | | | | Internal | | | |
|---|---|---|---|---|---|---|---|---|---|
| | Textured | Cooking | Holding | Lid | Time | Temp | | | Compression |
| Trial | proteins | method | method | covering | (min) | (° F.) | Appearance | Score | test at 60 min |
| 28 | Soy 1 | CO | S/F | Covered | 30 | 189 | Mushy, didn't | 1 | Half |
| | | | | | | | absorb all water | | disintegrated |
| 28 | Soy 1 | CO | S/F | Covered | 60 | 167 | Absorbed | 1 | paste-like |
| | | | | | | | all water | | |
| 29 | Soy 2 | CO | S/F | Covered | 30 | 188 | Mushy, didn't | 1 | Disintegrated, |
| | | | | | | | absorb all water | | paste-like |
| 29 | Soy 2 | CO | S/F | Covered | 60 | 162 | Absorbed | 1 | |
| | | | | | | | all water | | |
| 30 | Pea 2 | CO | S/F | Covered | 30 | 188 | Good | 4 | Retained |
| | | | | | | | appearance, | | shape |
| | | | | | | | absorbed | | |
| | | | | | | | all water | | |
| 30 | Pea 2 | CO | S/F | Covered | 60 | 165 | Released | 4 | |
| | | | | | | | water | | |
| 31 | Pea 3 | CO | S/F | Covered | 30 | 179 | Good | 5 | Retained |
| | | | | | | | appearance, | | shape, |
| | | | | | | | absorbed | | squeaky |
| | | | | | | | all water | | while |
| 31 | Pea 3 | CO | S/F | Covered | 60 | 172 | Released | 5 | pressing, |
| | | | | | | | water | | |

Soy 1 and Soy 2 samples disintegrated and became paste-like after compressing on a flat surface. Pea 2 and Pea 3 sprung back to their original shapes.

The remaining samples were then divided and stored separately in a refrigerator and a freezer to study cold and frozen storage stability. The visual appearance and texture of reheating samples were reported after refrigeration storage for a period of 1, 2, or 3 weeks prior to reheating. Ice formation was noted for the samples stored in a freezer for three weeks. The results are set forth below in Table 8.

TABLE 8

| | | Refrigeration storage | Freezer Storage |
|---|---|---|---|
| Soy 1 | Week | Mushy, syneresis | Ice crystals were |
| | 1 | Reheating did not bring | excessive at week 3 |
| | | back to optimal texture | |
| | Week | Really mushy | |
| | 2 | Reheating turned to mush | |
| | Week | Discarded, color changed, | |
| | 3 | syneresis | |
| Soy 2 | Week | Mushy, syneresis | Ice crystals were |
| | 1 | Reheating did not bring | excessive at week 3 |
| | | back to optimal texture | |
| | Week | Mushy | |
| | 2 | Reheating turned to mush | |
| | Week | Discarded, discolored, | |
| | 3 | syneresis | |
| Pea 2 | Week | Texture slightly mushy | Ice crystals were visible |
| | 1 | Returns to optimal | but much less than |
| | | quality after heating | soy samples at week 3 |
| | Week | Mushy, | |
| | 2 | Color remained the same | |
| | Week | Discarded, mushy | |
| | 3 | | |
| Pea 3 | Week | Mushy, syneresis | Ice crystals were visible |
| | 1 | Reheating did not bring | but much less than |
| | | back to optimal texture | soy samples at week 3 |
| | Week | Mushy | |
| | 2 | Reheating turned to mush | |
| | Week | Discarded - discolored, | |
| | 3 | presence of syneresis | |

Soy 1 and Soy 2 exhibited mushy texture and syneresis. It was theorized that water had leached out of the product after cold storage at Week 1. The soy samples turned paste-like after reheating on week 2. Pea 2 and Pea 3 exhibited slightly mushy texture but returned to optimal texture after reheating on week 1, and turned mushy on week 2. This indicated that Pea 2 and Pea 3 could be held in cold storage for 1 week, and still produce products with acceptable texture upon reheating. All products changed color and had unacceptable quality after week 3. Frozen samples were evaluated for ice crystals on week 3. Soy 1 and Soy 2 had excessive ice crystals, while Pea 2 and Pea 3 had some ice crystals.

### Example 4: Sensory Evaluation 1

In Sensory Evaluation 1, a blind taste test was conducted comprising 89 human participants. The participants were approximately 50% male and 50% female. Participants were asked to compare a plant-based meat alternative to an animal protein, each prepared with a pulled-pork or barbacoa seasoning. Each participant received 57 g of animal protein-based or plant-based pulled pork on a slider bun. Each participant received 14 g of protein-based or plant-based barbacoa filling served on a piece of tostito.

The animal protein-based pulled pork, plant-based pulled pork, animal protein-based barbacoa, and plant-based barbacoa were prepared for this evaluation as described below.

Animal protein-based pulled pork was prepared comprising 68% pork butt, 12% seasonings (brown sugar, chili powder, black pepper, all spice, garlic, onion, cumin, salt, cayenne, vinegar powder, worcestershire powder, total powder, honey powder, hickory flavor, and paprika), and 20% water. To prepare the pulled pork, trimmed pork butt was cooked in a hotel pan with a foil covering for 4 hours at 360° F. Fat was drained off the pan and pork butt was shredded by hand. The shredded pork but was then tossed in the seasonings. The seasoned, shredded pork but was cooked for 1-2 hours, vacuum sealed, and frozen immediately. Before serving, the pulled pork was reheated on a saute pan for approximately 10 min.

The plant-based pulled pork was prepared comprising 19% textured wheat protein (PROTERRA 1200C), 18% seasonings (brown sugar, chili powder, black pepper, allspice, garlic, onion, cumin, salt, cayenne, vinegar powder, Worcestershire powder, total powder, honey powder, hickory flavor, and paprika), and 63% water. The textured protein, seasonings, and water were mixed and the mixture was allowed to stand for 5 minutes. The mixture was then cooked on a skillet for 7-8 min.

Barbacoa seasoned animal protein-based beef was prepared comprising 95% beef chuck and 5% seasonings (smoked paprika, chipotle powder, onion, garlic, salt, cumin, oregano, black pepper, and cilantro). Beef chuck was divided into a one-pound portion, placed in a hotel pan with 2 cups of water, covered with foil, and cooked in an oven for 2 hours at 365° F. Once the beef was cooked and had cooled in a refrigerator, the beef was cut into approximately 0.5 inch cubes and combined with barbacoa seasoning. The mixture was vacuum sealed and frozen immediately. Before serving, the barbacoa seasoned animal protein-based beef was reheated on a saute pan for 10 min.

Barbacoa seasoned plant-based alternative meat was prepared comprising 21% textured wheat protein (PROTERRA 1200DC), 7% seasonings (smoked paprika, chipotle powder, onion, garlic, salt, cumin, oregano, black pepper, and cilantro), 10% oil, and 62% water. The textured protein, seasonings, and water were mixed, allowed to stand for 10 minutes, and then cooked on a skillet for 8 minutes.

In the blind taste test of this experiment, scores were provided by each participant for each sample on a scale of 1-10 (highest score being a 10) based on overall taste, visual appeal, aroma, and mouthfeel.

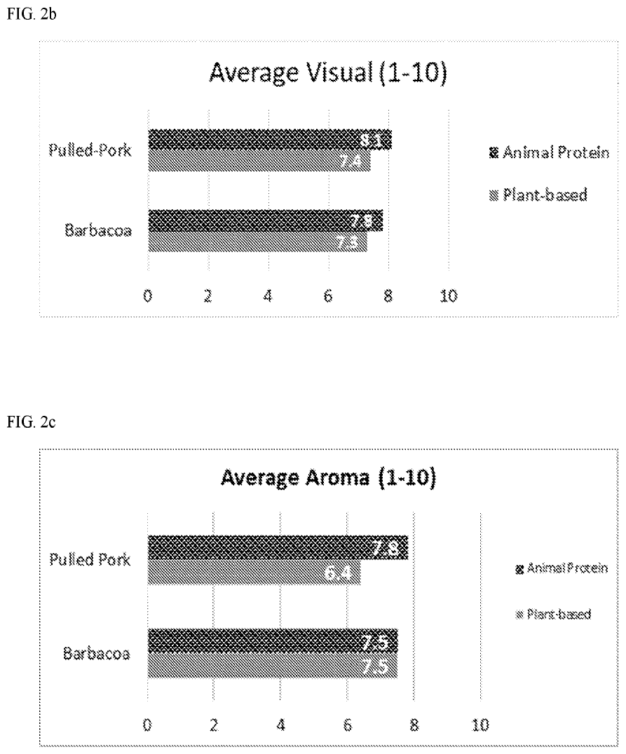

FIGS. 2a-2d report the average score for each evaluation category for both the pulled-pork and barbacoa recipes.

### Example 5: Sensory Evaluation 2

The hydration rate and seasoning recipes of the plant-based pulled pork and barbacoa were modified based on the results from Sensory Evaluation 1. The modified recipes were prepared in the manner described below.

The modified plant-based pulled pork comprised 33% Textured wheat protein (ProTerra 1200C), 18.2% seasonings (flavor enhancer, brown sugar, chili powder, black pepper, all spice, garlic powder, onion powder, cumin, vinegar powder, tomato powder, hickory flavor, and paprika) and 49% water.

The modified plant-based barbacoa comprised 23% textured wheat protein (ProTerra 1200DC), 7.2% seasonings (flavor enhancer, smoked paprika, chipotle powder, onion, garlic, salt, cumin, oregano, black pepper, and cilantro), 11.6% oil, and 58% water.

Both the modified plant-based pulled pork and modified plant-based barbacoa were prepared according to Table 9 cooking conditions for the convection oven, and were held on the steam table according to Table 10.

TABLE 9

| | Kitchen Equipment | | | | | |
|---|---|---|---|---|---|---|
| | Convection oven | | Standard oven | | Combi/steamer | |
| Temperature | 375° | F. | 375° | F. | 225° | F. |
| Cooking time | 15 | min | 25 | min | 3 | min |

| | | | |
|---|---|---|---|
| Pan covering | Covered | Covered | Uncovered |

TABLE 10

| Kitchen Equipment | | |
|---|---|---|
| | Steam Table/Buffet Line | Holding Oven |

| | | | | |
|---|---|---|---|---|
| Temperature | 160-180° | F. | 180° | F. max |
| Cooking time | 2 | hours | 2 | hours |

| | | |
|---|---|---|
| Pan covering | Uncovered | Covered |
| Note | Stir Occasionally | Stir Occasionally |

Fifty-five participants conducted a blind taste test of the modified plant-based pulled pork and barbacoa and indicated whether they were overall “Acceptable,” “Neutral,” or “Unacceptable.” 89% of the participants indicated that the modified plant-based pulled pork was Acceptable and 97% indicated that the modified plant-based barbacoa was Acceptable.

### Example 6: Sensory Evaluation 3

In Sensory Evaluation 3, chimichurri, barbacoa, tikka masala, and stroganoff recipes made with textured pea protein were evaluated.

Each of the recipes were prepared having the composition set forth in Table 11. The textured pea protein was PROTERRA 2100.

TABLE 11

| | | | | Tikka |
|---|---|---|---|---|
| Components | Chimichurri | Stroganoff | Barbacoa | Masala |
| Water | 64% | 71% | 64% | 64% |
| Textured Pea Protein | 26% | 19% | 26% | 26% |
| Seasonings | 7% | 7% | 7% | 7% |
| Oil | 3% | 4% | 3% | 3% |

The chimichurri, barbacoa, tikka masala, and stroganoff recipes prepared according to Table 11 were then subjected to the cooking and hot holding conditions used above in Example 5.

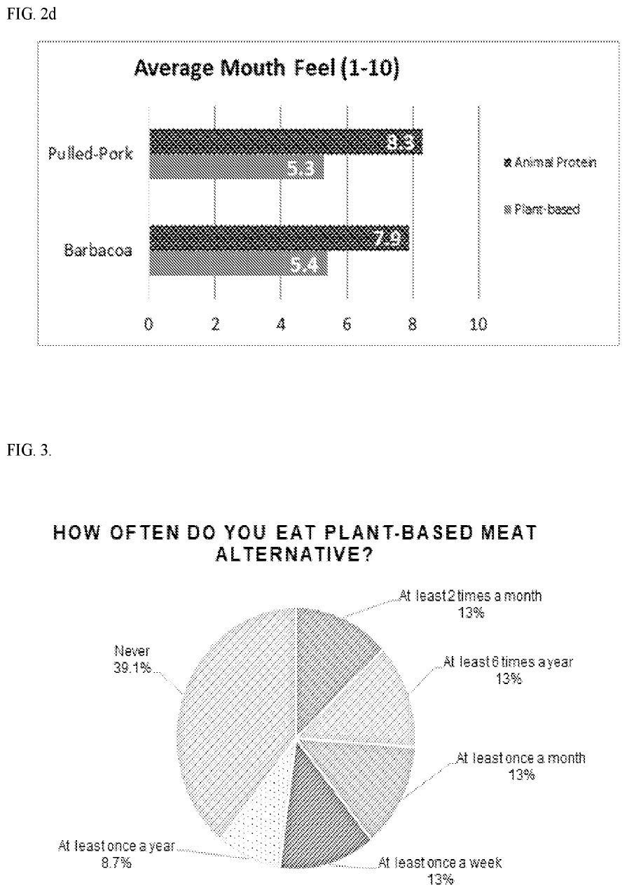

The twenty-three participants of this evaluation were comprised of persons having primarily meat-based diets. 60.8% of participants reported consuming plant-based meals a maximum of once every two months and only 13% of participants reported consuming plant-based meals at least once a week. A summary of the frequency of plant-based meat alternatives in the participants' diet is set forth in FIG. 3.

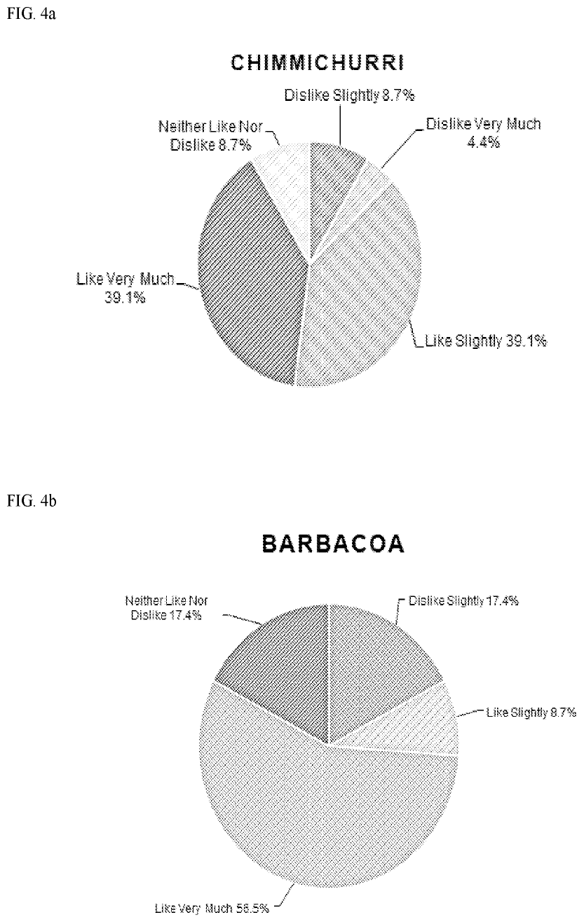

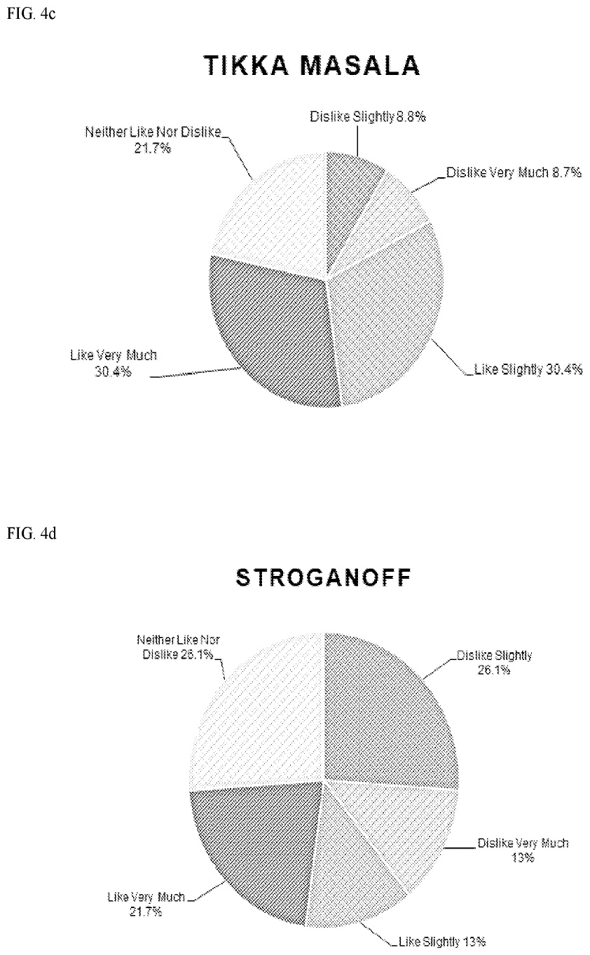

The participants were instructed to rate each product with “Like Very Much,” “Like Slightly,” “Neither Like nor Dislike,” “Dislike Slightly,” or “Dislike Very Much.” The results are set forth in FIGS. 4a-4d.

The participants were also asked to pick their two preferred dishes. The results of this question are set forth in FIG. 5.

### Example 7: Sensory Evaluation 4

Sensory Evaluation 4 repeated the experiment of Example 6. However, in this experiment, the participants comprised restaurant managers, operators, chefs, and foodservice buyers from the Greater Kansas City Chef Association (Kansas City, MO).

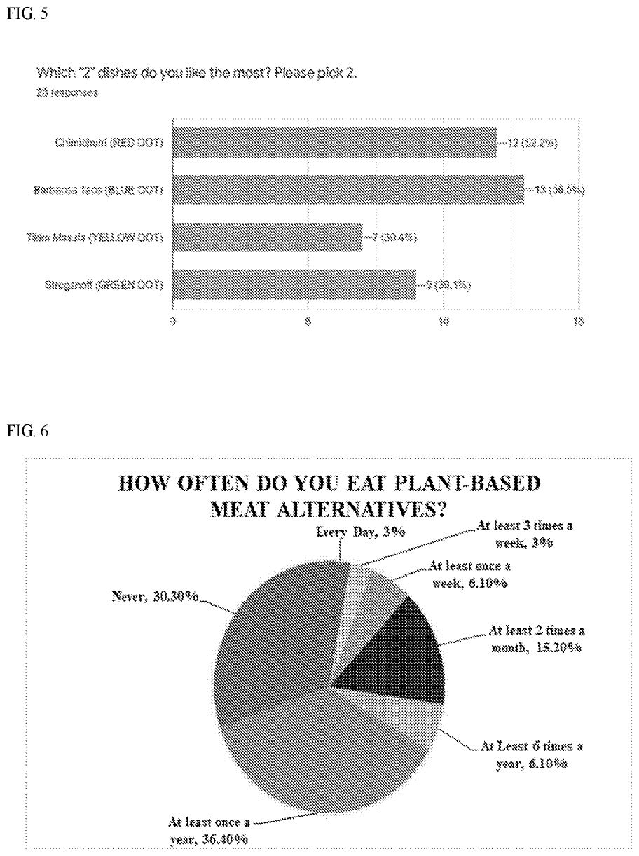

How often the 33 participants of this evaluations consumed plant-based meals is set forth in FIG. 6.

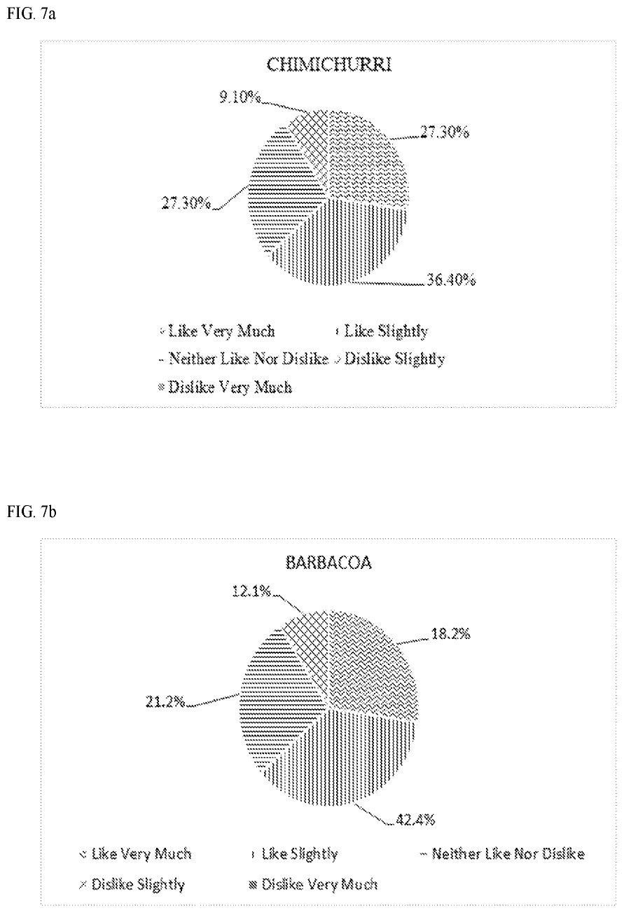

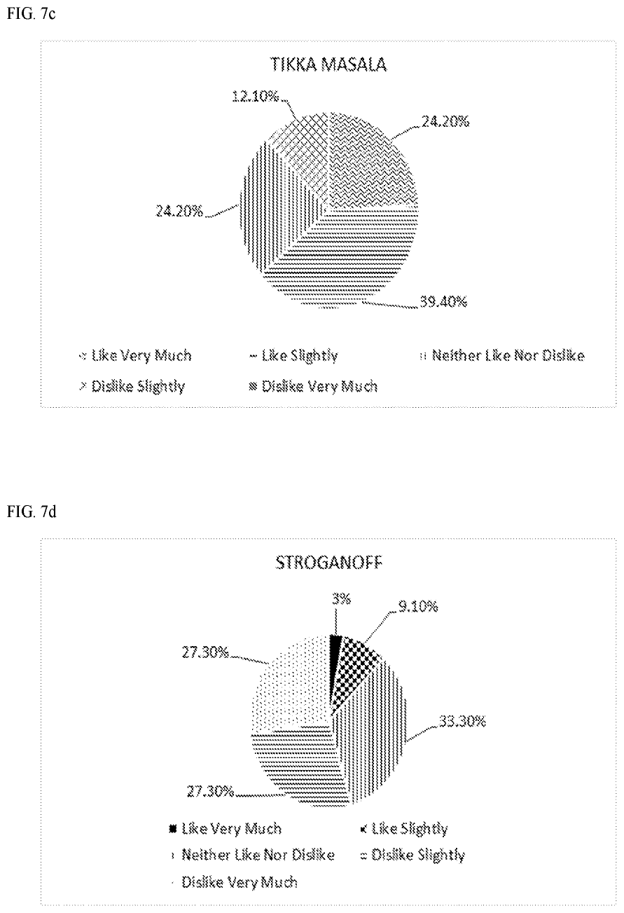

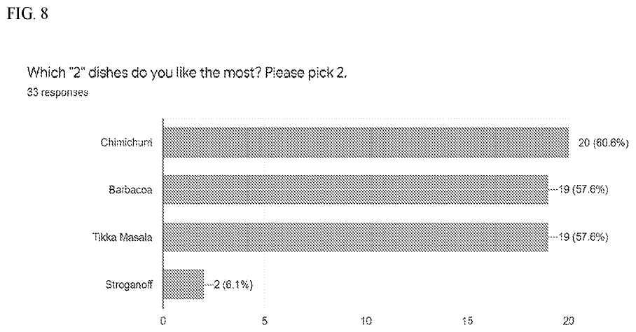

The results of the evaluation for plant-based chimichurri, barbacoa, tikka masala, and stroganoff on a “Like Very Much,” “Like Slightly,” “Neither Like nor Dislike,” “Dislike Slightly,” or “Dislike Very Much” scale are set forth in FIGS. 7a-7d.

The results when each participant was asked to pick their two preferred dishes is set forth in FIG. 8.

### Example 8: Durability Testing

An experiment was conducted to test the integrity of the textured proteins in three types of packaging materials: 1) Stand-up pouch (7½″ Width×14¼″ Height×4½″ Gusset), 2) Carton box (5½″ Width×70½″ Height×5½″ Depth), and 3) Vertical Form Fill and Seal (VFFS) bags (8¼″ Width×14″ Height). The stand-up pouch was packaged vertically and individually, while the VFFS bags were stacked. Packages were filled with textured proteins, arranged in a shipping box, and sealed. The packages were dropped from 4-foot height 15 times to simulate delivery and handling practices. The packages were then placed in a car trunk and driven for 120 miles. Containers and the contents were then evaluated by separating the fines from the textured protein via sifting. The amount of fine particles (fines) were then calculated as Fines/Total textured protein weight×100=% Fines.

The drop test results showed that stand-up pouch and VFFS (Vertical Form Fill and Seal) bags and stand-up pouch had the least fines. The top VFFS bag yielded 2.7% fines, while the bottom bag yielded 6.9% fines. Stand-up pouch yielded 5.6% fines, and the carton box yielded 9.2% fines. On the basis of these results, the stand-up pouch was chosen for the commercialization of seasoned textured protein.

### Example 9: Nutritional Analysis

Table 12, below, sets forth the results of a nutritional analysis for 100 g of textured wheat protein, textured pea protein, and textured pea protein with added chimichurri or barbacoa seasoning. The textured proteins were submitted to Medallion Labs (Minneapolis, MN) for full nutritional analysis and in vitro PDCAAS. LOQ refers to limit of quantitation.

TABLE 12

| | | | Textured | | Textured Pea | Textured Pea |
|---|---|---|---|---|---|---|
| | | | Wheat | Textured | Protein with | Protein with |
| | | | Protein | Pea | Chimmichuri | Barbacoa |
| Method: | Component: | Units | (1200 C) | Protein | seasoning | seasoning |
| Ash | Ash | % | 2.48 | 4.08 | 7.5 | 6.4 |
| ² Calories | Calories | Calories/ | 363.3 | 411.3 | 371.5 | 379.5 |
| | | 100 g | | | | |
| | Calories, 2020 | Calories/ | 363.3 | 411.3 | 371.5 | 379.5 |
| | | 100 g | | | | |
| | Calories from | Calories/ | 44.1 | 69.4 | 52.5 | 61.0 |
| | Fat | 100 g | | | | |
| ² Carbohydrates | Carbohydrates | % | 25.31 | 6.49 | 17.7 | 17.1 |
| Cholesterol | Total | mg/100 g | LOQ | LOQ | LOQ | LOQ |
| | Cholesterol | | | | | |
| Fat (Gas | Total Fat | % | 4.89 | 0.1 | 5.8 | 6.8 |
| Chromatography) | | | | | | |
| | Saturated Fat | % | 1.12 | 1.47 | 1.2 | 1.3 |
| | Monounsaturated | % | 0.74 | 2.12 | 1.6 | 1.7 |
| | Fat | | | | | |
| | cis-cis | % | 3.01 | 3.89 | 2.8 | 3.1 |
| | Polyunsaturated | | | | | |
| | Fat | | | | | |
| | trans Fat | % | 0.02 | 0.1 | <LOQ | 0.4 |
| Fiber (AOAC | Total Dietary | % | 6.7 | 1.94 | 3.9 | 4.8 |
| 991.43) | Fiber | | | | | |
| Metals (ICP- | Calcium | mg/100 g | 50 | 90.1 | 141.5 | 166.0 |
| OES) | | | | | | |
| Metals (ICP- | Iron | mg/100 g | 2.6 | 18.5 | 18.0 | 19.9 |
| OES) | | | | | | |
| Metals (ICP- | Potassium | mg/100 g | 690 | 110 | 418.5 | 496.0 |
| OES) | | | | | | |
| Metals (ICP- | Sodium | mg/100 g | 238 | 1040 | 2145.0 | 1650.0 |
| OES) | | | | | | |
| Moisture by | Moisture | % | 8.4 | 2.73 | 6.9 | 7.2 |
| Forced Air | | | | | | |
| Oven | | | | | | |
| | Protein | % | 58.92 | 78.99 | 62.1 | 62.6 |
| | Total Sugar | % | 0.18 | 0.1 | 2.8 | 1.2 |
| Vitamin D | Vitamin D3 | mcg/100 | <1 | 0 | <0.500 | <0.500 |

1. A method of preparing a plant-based food product comprising a plant-based composition, wherein the method comprises:
mixing a textured protein and seasoning to prepare the plant-based composition;
combining the plant-based composition and water to form a hydrated plant-based composition; and
cooking the hydrated plant based composition to form the plant-based food product;
wherein the weight ratio of textured protein to seasoning in the plant-based composition is from about 20:1 to about 2:1; and
wherein the plant-based food product maintains a commercially acceptable appearance, quality, and structure after hot holding at a temperature of from about 135° F. to about 212° F. for a period of about 10 minutes or less.

2. A method of hot holding a plant-based food product, comprising:
preparing a plant-based food product comprising a plant-based composition comprising a textured protein and seasoning, wherein the weight ratio of textured protein to seasoning is from about 20:1 to about 2:1;
placing the plant-based food product in a container; and
maintaining the container at a temperature of from about 135° F. to about 212° F. for a period of about 150 minutes or less.

3. The method of claim 2, wherein the container is selected from the group consisting of a steam table, buffet line, or oven.

4. The method of claim 1, wherein the seasoning comprises at least about 1 wt % of the plant-based composition.

5. The method of claim 1, wherein at least a portion of the textured protein is derived from wheat, pea, corn, fungus, or other plant sources.

6. The method of claim 1, wherein the textured protein comprises a textured wheat protein.

7. The method of claim 6, wherein the textured wheat protein is produced by extrusion of wheat gluten with wheat starch, tetrapotassium pyrophosphate, caramel color, sodium carbonate, and mixed tocopherols as processing aids.

8. The method of claim 1, wherein the textured protein comprises a textured pea protein.

9. The method of claim 8, wherein the textured pea protein is produced by extrusion of pea protein isolate.

10. (canceled)

11. The method of claim 9, wherein the pea protein isolate further comprises additives, wherein the additives consist of tapioca starch, sodium carbonate, mixed tocopherols, and combinations thereof.

12. (canceled)

13. (canceled)

14. The method of any one of claim 8, wherein the textured pea protein has a protein quality of 0.81 based on the in vitro PDCAAS (Protein Digestibility Corrected Amino Acid Score) value.

15. The method of any one of claim 1, wherein the seasoning is selected from the group consisting of barbacoa seasoning, chimichurri seasoning, tikka masala seasoning, stroganoff seasoning, pulled pork BBQ seasoning, and combinations thereof.

16. (canceled)

17. (canceled)

18. (canceled)

19. (canceled)

20. (canceled)

21. The method of claim 1, wherein the nutritional value of the plant-based food product comprises about 11 g of protein, about 1 g of fat, about 1 g of fiber, and about 70 calories per serving size of about 18 g (¼ cup).

22. The method of claim 1, wherein the plant-based food product is prepared by a process comprising:
mixing the textured protein and seasoning for about 1 minute to prepare the plant-based composition;
combining the plant-based composition and water for about 2 minutes to form a hydrated plant-based composition; and
cooking the hydrated plant-based composition for about 6 minutes in a combi/steamer to form the plant-based food product.

23. The method of claim 1, wherein the plant-based food product is prepared by a process comprising:
mixing the textured protein and seasoning for about 1 minute to prepare the plant-based composition;
combining the plant-based composition and water for about 2 minutes to form a hydrated plant-based composition; and
cooking the hydrated plant-based composition for about 20 minutes in a convection oven to form the plant-based food product.

24. (canceled)

25. The plant-based food product of the method of claim 2, wherein the plant-based food product is hot held in a container selected from a steam table or buffet line for about 2 hours at about 180° F. without deterioration of product quality.

26. (canceled)

27. The method of claim 1, wherein the plant-based food product can be compressed without disintegrating into a paste after cooking and hot holding for 60 min.

28. The method of claim 1, wherein the plant-based food product can be stored in a refrigerator for 2 weeks with minimal water leaching out of the product, and retain its textural quality after reheating.

29. The method of claim 1, wherein the plant-based food product can be stored in the freezer with minimal ice crystal formation and retention of its textural quality after reheating.

30. A plant-based food product comprising a plant-based composition comprising a textured protein and seasoning;
wherein the weight ratio of textured protein to seasoning in the plant-based composition is from about 20:1 to about 2:1; and
wherein the plant-based food product maintains a commercially acceptable appearance, quality, and structure after hot holding at a temperature of from about 135° F. to about 212° F. for a period of about 10 minutes or less.
